(19) United States
(12) Patent Application Publication
(10) Pub. No.: US 2011/0084589 A1
(43) Pub. Date: Apr. 14, 2011

(54) VIBRATION RESISTANT ELECTRIC INCANDESCENT LAMP AND METHOD FOR REDUCING VIBRATION

(75) Inventors: Tamás Torma, Budapest (HU); István Magai, Biatorbagy (HU); László Makai, Tamasi (HU); Zsolt Kapocs, Budapest (HU)

(73) Assignee: General Electric Company

(21) Appl. No.: 12/578,143

(22) Filed: Oct. 13, 2009

(51) Int. Cl. H01J 19/12

(52) U.S. Cl. 313/269

(57) ABSTRACT

An electric incandescent lamp comprising at least one incandescent filament is provided. The incandescent filament is arranged inside a translucent envelope. The lamp also comprises support wires that protrude out of a stem. The filament has end portions, and each end portion is fixed to a corresponding support wire at a junction point. At least one of the support wires comprises at least one narrowed portion for reducing vibration. The narrowed portions are disposed between the junction point and the stem. In an exemplary embodiment of another aspect of this invention, at least one of the support wires has a second section overhanging beyond the junction point of the end portion of the filament. The at least one narrowed portion for reducing vibration is comprised by the second section. A method for reducing vibration is also disclosed. This method comprises a step of forming at least one narrowed portion in at least one of the support wires.

### BACKGROUND OF THE INVENTION

This invention relates to an electric incandescent lamp that is vibration resistant.

Various electric incandescent lamps known in the art that have quite shock sensitive filament. These lamps have an envelope and a stem within the envelope, and support wires protruding out of the stem. In several technical applications, such as in automotive lamps, the filament structure together with the support wires is subject to shock and vibration. This shock and vibration may lead to irreversible damage of the filament, especially in cases of resonance. In order to avoid the afore-mentioned drawbacks manufacturers tend to strengthen the support wires.

As an example we refer to U.S. Patent Application No. 2006/0043898A1. This application relates to an electric incandescent lamp, in particular a vehicle headlight lamp that has an incandescent filament, arranged inside a transparent lamp envelope, and supply leads for the incandescent filament, at least one of the supply leads is provided with at least one reinforcing strut in order to improve the vibration strength of the lamp. The additional element, the strut, involves additional manufacturing expenses. In spite of this, the resulted structure will not be sufficiently resistant to some vibrations that frequently occur in case of headlamps. The additional strut makes the holder element harder, but its vibration transfer function is worse, due to the harder spring system. So the filament in this structure still remains exposed to some degree of vibration.

In order to increase the efficiency of the vibration tittering and damping, the support wires should be provided with features that help avoid resonances.

Therefore, there is a need for vibration resistant lamps including an incandescent filament. where the manufacturing costs will not increase substantially relative to the usual expenses.

### SUMMARY OF THE INVENTION

In an exemplary embodiment of the present invention, an electric incandescent lamp is provided. The lamp comprises at least one incandescent filament arranged inside a translucent envelope and support wires having across sectional area and protruding out of a stem. The filaments have end portions, and each end portion is fixed to a corresponding support wire at a junction point. At least one of the support wires comprises a narrowed portion for reducing vibration. The at least one narrowed portion is disposed between the junction point and the stem. This exemplary embodiment forms a vibration filtering system.

In an exemplary embodiment of another aspect of this invention, an electric incandescent lamp is provided that comprises at least one incandescent filament being arranged inside a translucent envelope, support wires having a cross sectional area and protruding out of a stem. the filaments having end portions, each end portion being fixed to a corresponding support wire at a junction point, the support wires having a first section extending between the junction point and the stem. At least one of the support wires has a second section overhanging beyond the junction point. The second section comprises at least one narrowed portion for reducing vibration. This exemplary embodiment forms a vibration damping system.

In an exemplary embodiment of a further aspect of this invention, a method of reducing vibration in an electric incandescent lamp is provided. The lamp comprises at least one incandescent filament arranged inside a translucent envelope and support wires having a cross sectional area. The filaments have end portions each end portion is fixed to a corresponding support wire. The method comprises the step of forming at least one narrowed portion in at least one of the support wires.

This invention has several advantages over the prior art. Vibration resistance of the lamp filament is increased without the use of additional element while selecting the dimensions of the narrowed portion properly preserves the mechanical strength of the support wire. The support wire with the narrowed portion itself provides for filtering and damping the vibration of the incandescent filament-support wire system. Positioning of the narrowed portion, adjusting its dimensions and the selection of the number of the narrowed portions offer a broad variety for tuning off the resonant frequency of the filament-support wire system from the outside excitation frequencies causing harmful vibration.

### BRIEF DESCRIPTION OF THE DRAWINGS

The invention will now be described with reference to the enclosed drawings, in which

FIG. 1 is a side view of a lamp with a filament and support wires,

FIG. 2 is a side view of a support wire with a narrowed portion of a first exemplary embodiment of the invention,

FIG. 3 is a side view of a support wire of the second exemplary embodiment of the invention,

FIG. 4 is a side view of a support wire with turned back end portion,

FIG. 5 is a side view of a support wire with a separate piece end portion,

FIG. 6 is an enlarged side view of a support wire comprising a narrowed portion,

FIG. 7 is a perspective view of a support wire with a flattened narrowed portion,

FIG. 8 is a perspective view of a support wire including two narrowed portions prepared with different technologies.

### DETAILED DESCRIPTION OF THE INVENTION

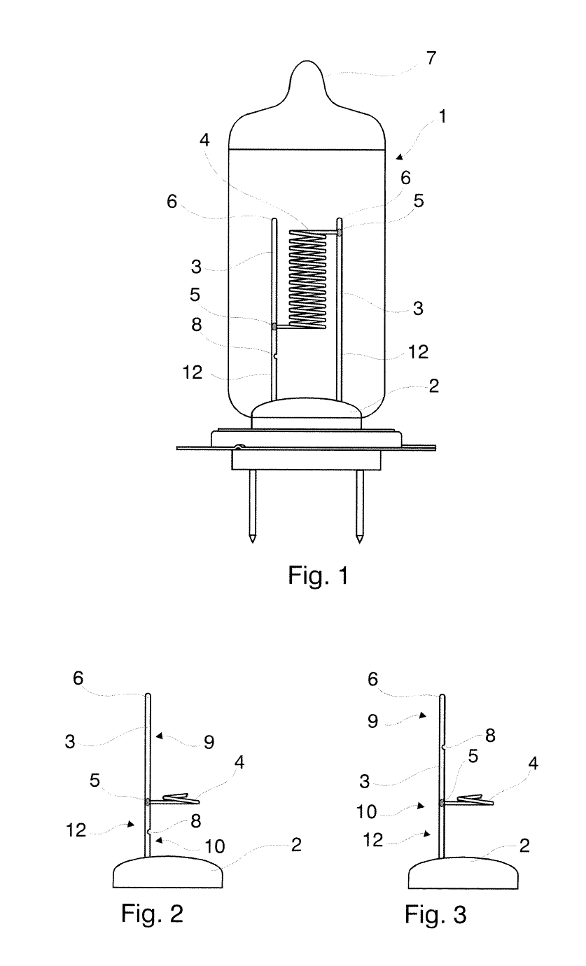

Referring now to FIG. 1, there is shown an incandescent lamp 1. The lamp 1 has a stem 2 and support wires 3 embedded in and protruding out of the stem 2. The support wires 3 may for example be made of molybdenum or other metals or metal alloys. Material of the stem may be glass. An incandescent filament 4 is fixed to the support wires 3 at end portions of this filament 4. The filament may be made of tungsten. The support wires 3 have a first section 12 extending from the stem 2 to a junction point 5, each end portion of the filament 4 is fixed to a corresponding support wire 3 at its junction point 5. The fixing of the support wires 3 at junction points 5 can be effected by welding, pressing. crimping, or other appropriate manufacturing technology, which provides sufficient mechanical and electrical connection. The junction points 5 of the support wires 3 are not necessarily disposed at their ends. There may be a second section 6 overhanging beyond the junction point 5 viewing from the stem 2. The support wires generally have a cross section area unchanged in longitudinal direction. The support wires are also called wire electrodes. The cross section of the support wires 3 can be circular, oval, rectangular or any other shape. The support wires 3 and the filament 4 are arranged inside a translucent envelope 7. More than one filament may also be arranged in the translucent envelope 7, as a person skilled in the art knows it. The filaments in this case are fixed to corresponding support wires.

One of the support wires 3 comprises a narrowed portion 8 in its first section 12 between the junction point 5 and the stem 2 as an exemplary embodiment of the invention. The narrowed portion 8 divides the support wire 3 into two coupled sections, a third section 10 and a fourth section 9 as it is shown in FIG. 2. Transversal pinching, stamping, sawing or abrasion can be used for forming the narrowed portion in the corresponding support wire. The measure of narrowing the cross section area in the narrowed portion 8 may be 60% to 40% of the transversal cross section area of the support wire 3. In other words, the cross section area of the narrowed portion may be set at 40% to 60% of the entire transversal cross section area of the support wire. The structure of the support wires 3 embedded in the stem 2 and the filament 4 together form a vibration system that has a resonant frequency. The narrowed portion provides a well-defined shift of the resonant frequency in the vibration system. More than one narrowed portion may also be used for fine-tuning the resonant frequency of the incandescent filament-support wire system. As a result, the amplitude of the deflection of the filament from its equilibrium position is reduced, and the vibration strength of the incandescent lamp is increased, while the supporting wire 3 still shows a good and durable supporting feature. Test results indicate that the amplitude deflection of a filament mounted on a support wire with a narrowed portion of cross section area of 50% of the cross section area of the support wire is one quarter of the amplitude deflection of the filament mounted on the same support wire without narrowed portion.

FIG. 3 shows a second exemplary embodiment of the invention. In this embodiment, the narrowed portion 8 in the support wire 3 is located in the second section 6. By putting the narrowed portion 8 in this second section 6, a vibration system is formed, in which an added resonator is created. The fourth section 9 together with the narrowed portion 8 forms this added resonator. The vibration of the third section 10 provides excitation for the added resonator. The added resonator however vibrates in opposite phase with respect to the third section 10 at its resonant frequency. As a result, the added resonator decreases the vibration of the third section 10 at its resonant frequency, which is adjusted to the resonant frequency of the third section 10. In this manner, the resonance of the overall structure of the support wires 3 and the filament 4 may be shifted to a frequency, which rarely occurs under real conditions that excite vibration. The second section 6 contains the added resonator that may be tuned by the location of the narrowed portion 8 in the second section 6 of the support wire 3 and the measure of narrowing. More than one narrowed portion in the second section 6 may provide finer tuning possibility.

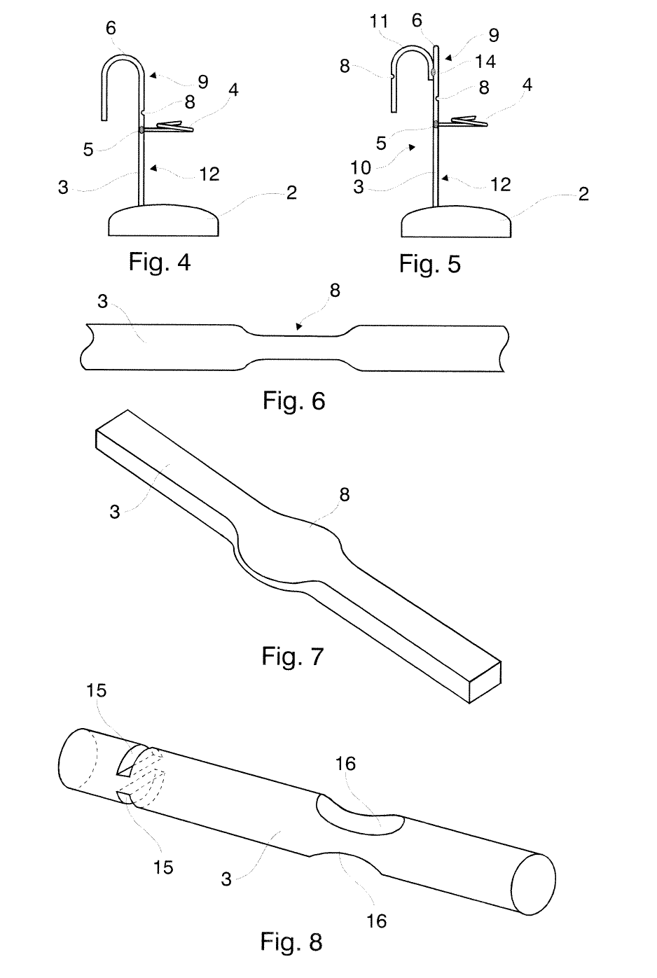

Referring now to FIG. 4, there is shown a support wire 3 for use in an incandescent lamp 1. This support wire 3 has a second section 6, which is turned back. The turned back end portion extends off the filament 4 and has a radius, which allows sufficient space occupation within the envelope 7. The second section 6 includes a narrowed portion 8. This narrowed portion 8 can either be in the straight, or in the curved, or in the back directed end portion of the second section 6. The turned back portion modifies the mass of the second section 6. This has an impact on the resonant frequency of the added resonator, namely reduces its resonant frequency. Dimensions of the support wire in the first section 12 is selected to ensure the strength of the support wire 3 thereby its resonant frequency generally is lower than the resonant frequency of the second section 6. Due to the turned back portion, the measure of narrowing may be smaller, which results in a more robust support wire structure.

As a further possible embodiment, the turned back portion can be a separate piece 11 attached to the second section 6 of the straight support wire 3 by welding or similar technology as shown in FIG. 5. The welding point 14 is a junction in the straight second section 6 of the support wire 3 including a narrowed portion 8. The attached separate piece 11 may include a further narrowed portion 8. This embodiment allows the vibration generated by two or more excitation frequencies to be reduced. Of course any of the two narrowed portions 8 can be eliminated, while the resonance tuning off can still be accomplished.

The narrowed portion 8 in the support wire 3 shown in FIG. 6 can be prepared by several different technologies. The substantially constant transversal cross section area of the support wire 3 is preferably reduced to a range of 60% to 40% or more preferably to 50% of its original transversal cross section area. This measure is a possible way to tune the resonance, and thus the safe operational range of the overall system with the filament 4. Calculation of resonant frequency is based on vibration theory that is known to a person skilled in the art.

In a method of reducing vibration in an electric incandescent lamp 1 that have support wires 3 with a cross sectional area, and comprises at least one incandescent filament 4 inside a translucent envelope 7, further the filament 4 is provided with end portions, while each end portion is fixed to a corresponding support wire, the method comprises the step of forming at least one narrowed portion 8 in at least one of the support wires 3.

The narrowed portion 8 in the support wire 3 can also be prepared by transversal flattening. Two stamping dies can be used for flattening the support wire 3. As shown in FIG. 7, the flattening forms the narrowed portion 8 in the support wire. As a matter of fact, the cross sectional area of the support wire 3 is not reduced in this case, however a bending inertia belonging to the cross sectional area of the support wire 3 is reduced. This means that a smaller force is sufficient for bending the support wire 3, which results in a lower resonant frequency.

The narrowed portion 8 in the support wire 3 can alternatively be prepared as a pair of transversal abrasions 16. In FIG. 8, an upper and lower half parts of abrasions 16 are shown together with an alternative further way of preparation of the narrowed portion by a pair of saw-cuts 15. Be the narrowed portions 8 prepared in any way, the result is the same: the tuning off of the resonant frequency of the support wire and filament assembly. This in turn leads to the reduction of vibration.

The narrowed portion 8 in the support wire 3 can be prepared in the form of a transversal single narrowing or an opposite pair of narrowings in any way described above or in a similar way.

The substantial effect of the tuning off the resonance of the support wire and filament assembly is obviously advantageous over the prior art and will not require further substantial technical and economical investments at the same time.

The invention is not limited to the shown and disclosed embodiments, but other elements, improvements and variations are also within the scope of the invention. For example, the proposed structure is well suitable for manufacturing not only automotive lamps, but also any other lamps with filament.

1. An electric incandescent lamp comprising
at least one incandescent filament being arranged inside a translucent envelope;
support wires having a cross sectional area and protruding out of a stem;
the filaments having end portions, each end portion being fixed to a corresponding support wire at a junction point;
at least one of the support wires comprising at least one narrowed portion for reducing vibration, on, the at least one narrowed portion being disposed between the junction point and the stem.

2. The incandescent lamp of claim 1, in which the cross sectional area of the at least one narrowed portion is 60% to 40% of the cross sectional area of the at least one of support wires.

3. The incandescent lamp of claim 1, in which the cross sectional area of the at least one narrowed portion is 50% of the cross sectional area of the at least one the support wires.

4. The incandescent lamp of claim 1, in which a bending inertia belonging to the cross sectional area of the at least one of the support wires is reduced in the at least one narrowed portion.

5. The incandescent lamp of claim 4, in which the at least one narrowed portion is a flattening in the at least one of the support wires for reducing the bending inertia thereof.

6. The incandescent lamp of claim 1, in which the at least one narrowed portion is a transversal abrasion in the at least one of the support wires.

7. The incandescent lamp of claim 1, in which the at least one narrowed portion is a transversal saw-cut in the at least one of the support wires.

8. An electric incandescent lamp comprising
at least one incandescent filament being arranged inside a translucent envelope;
support wires having a cross sectional area and protruding out of a stem;
the filaments having end portions, each end portion being fixed to a corresponding support wire at a junction point;
the support wires having a first section extending between the junction point and the stem, and at least one of the support wires having a second section overhanging beyond the junction point;
the second section comprising at least one narrowed portion for reducing vibration.

9. The incandescent lamp of claim 8, in which the at least one narrowed portion is disposed also in the first section.

10. The incandescent lamp of claim 8, in which the cross sectional area of the at least one of the support wires is reduced in the at least one narrowed portion.

11. The incandescent lamp of claim 10, in which the cross sectional area of the at least one narrowed portion is 60% to 40% of the cross sectional area of the at least one of support wires.

12. The incandescent lamp of claim 11, in which the cross sectional area of the at least one narrowed portion is 50% of the cross sectional area of the at least one of the support wires.

13. The incandescent lamp of claim 8, in which a bending inertia belonging to the cross sectional area of the at least one of support wires is reduced in the at least one narrowed portion.

14. The incandescent lamp of claim 8, in which the second section is substantially straight.

15. The incandescent lamp of claim 8, in which the second section comprises a substantially straight portion and a turned back end portion.

16. The incandescent lamp of claim 8, in which the second section comprises a substantially straight portion and a turned back end portion of separate piece attached to the substantially straight portion.

17. The incandescent lamp of claim 16, in which the turned back end portion of separate piece is welded to the substantially straight portion.

18. The incandescent lamp of claim 15, in which the at least one narrowed portion is disposed in the substantially straight portion.

19. The incandescent lamp of claim 15, in which the at least one narrowed portion is disposed in the turned back end portion.

20. The incandescent lamp of claim 16, in which the at least one narrowed portion is disposed in the turned back end portion forming the separate piece.

21. A method of reducing vibration in an electric incandescent lamp comprising support wires having a cross sectional area and at least one incandescent filament inside a translucent envelope, the filament having end portions, each end portion being fixed to a corresponding support wire, the method comprising the step of forming at least one narrowed portion in at least one of the support wires.

22. The method of claim 21. in which the at least one narrowed portion is formed by transversal abrasion of the at least one of the support wires.

23. The method of claim 21, in which the at least one narrowed portion is formed by a transversal saw-cut in the at least one of the support wires.

24. The method of claim 21, in which the at least one narrowed portion is formed by flattening the at least one of the support wires for reducing a bending inertia belonging to the cross sectional area thereof.
